(19) United States
(12) Patent Application Publication
(10) Pub. No.: US 2014/0149250 A1
(43) Pub. Date: May 29, 2014

(54) METHOD AND APPARATUS FOR AUTHENTICATING BANK TRANSACTIONS UTILIZING AN ELECTRONIC WAFER

(71) Applicant: KITARU INNOVATIONS INC., Lascelles (BB)

(72) Inventor: Kapoor Chandaria, Nairobi (KE)

(73) Assignee: KITARU INNOVATIONS INC., Lascelles (BB)

(21) Appl. No.: 13/688,799

(22) Filed: Nov. 29, 2012

(51) Int. Cl. G06Q 20/32

(52) U.S. Cl. CPC G06Q 20/3227; G06Q 20/40145; G06Q 30/0609
USPC 705/26.35; 455/411; 705/35; 705/41

(57) ABSTRACT

A system and method of verifying a financial transaction at least partially conducted at an electronic device is authorized transaction is presented. First, the method determines that a request for a financial transaction is being requested at the electronic device. Upon that detection, biometric data from an electronic chip in the electronic device is read. Biometric data such as facial features and/or fingerprints are taken from the user of the electronic device. Biometric data stored in an electronic chip stored in the electronic device is compared the biometric data received from the user to determine if the user is the owner of the electronic device. The method allows the financial transaction to be conducted with the electronic device when the user of the electronic device is the owner of the electronic device and prevents the financial transaction when the user is not the owner of the electronic device.

### BACKGROUND

1. Field of Invention

The current invention relates generally to apparatus, systems and methods for conducting banking transactions. More particularly, the apparatus, systems and methods relate to conducting electronic banking transactions. Specifically, the apparatus, systems and methods provide for authenticating banking transactions using an electronic wafer.

2. Description of Related Art

It is now widely accepted in the domestic consumer market that purchasing or selling goods or services with credit cards at point of sale (POS) terminals, performing electronic transfer of funds at automated teller machine (ATM) terminals using ATM cards is more efficient than using cash to pay for goods or services or paying debts. Utilizing cash as a means for purchasing goods or paying debts is generally viewed as burdensome for several reasons. First, in terms of accounting, the consumer must manually generate records and reconcile his or her accounts to keep track of such cash transactions. By utilizing a credit card issued by a financial institution, however, consumer transactions are recorded by such financial institutions and accountings are provided to the consumer on a monthly basis which provides improved accounting and reconciliation.

In addition, using cash is a financially insecure method for protecting consumers against fraud and theft. For example, if a consumer believes that he or she has been sold an inferior or over-priced product, which frequently occurs during quick consumer transactions where the consumer may not have adequate time to reflect on the purchase until some time after such purchase, it is much easier for the consumer to contact the financial institution to stop payment on goods purchased using a credit card than it is for the user to recover cash from the merchant from whom such goods were bought. Moreover, it is virtually impossible for a consumer to recover cash that has been stolen or lost. On the other hand, if the consumer's credit cards are stolen or lost, the consumer can contact the corresponding financial institution to cancel such cards and obtain new credit card accounts.

Accordingly, there is a strong trend today in moving towards a “cashless society,” which has caused a substantial increase in the use of credit cards, ATM cards and direct debit cards (collectively, “financial cards”) for performing consumer transactions. Notwithstanding the perceived benefits of using financial cards rather than cash, there exists several disadvantages in using these cards. For example, if the consumer frequently uses a significant number of financial cards, the consumer must physically possess all such cards in order to access a desired account. Having to carry such a large number of financial cards can be extremely burdensome to the consumer since a substantial amount of space is occupied by these cards in the consumer's wallet or purse. Moreover, if the wallet or purse is lost or stolen, the consumer must contact the financial institution for each financial card to cancel the account so as to prevent an unauthorized user from transacting business with such cards which is also a burdensome task.

Another disadvantage in using financial cards is that consumers are not fully protected from the unauthorized use of lost or stolen cards. For example, a merchant can confirm the ownership of a credit card during a consumer transaction by comparing the authorized signature that is (or should be) written on the back of the credit card with the signature of the person signing the credit card receipt. Realistically, merchants generally do not compare these signatures during such a transaction, and even if they do, they may not compare such signatures with the level of scrutiny or skill needed to distinguish minor differences between the consumer's signature and the unauthorized user's forged signature. Therefore, during the period of time between the time the consumer's credit card is lost or stolen and the time the consumer realizes such loss or theft and cancels the account, an unauthorized user who has found or stolen the card may charge a substantial amount of money to the consumer's card. This leaves the consumer with the burden of having to dispute such unauthorized charges with the financial institution. Therefore, a better way of authenticating banking transaction is needed.

### SUMMARY

The preferred embodiment of the invention includes an electronic device capable of authorizing financial transactions. The electronic device can be a cellular telephone. The electronic device includes an electronic chip and a memory in the chip. The electronic may be formed out of a silicon wafer. The memory stores biometric data of an owner of the electronic device preferably when it is purchased or assigned to the owner. The electronic device is configured to detect that a request for a financial transaction is being made at the electronic device. Upon that detection, the electronic device is configured to receive biometric data from a user of the electronic device and compare it to the biometric data stored in the memory to determine if the user of the electronic device is the owner of the electronic device. The electronic device allows the financial transaction proceed when the user is the owner and not to proceed when the user is not the owner.

Another configuration of the preferred embodiment is a method of verifying a financial transaction at least partially conducted at an electronic device is an authorized transaction. First, the method determines that a request for a financial transaction is being requested at the electronic device. Upon that detection, biometric data from an electronic chip in the electronic device is read. At the time of the request for the financial biometric data such as facial features and/or fingerprints are taken from the user of the electronic device. Biometric data stored in the electronic chip stored in the electronic device is compared the biometric data received from the user to determine if the user is the owner of the electronic device. The method allows the financial transaction to be conducted with the electronic device when the user of the electronic device is the owner of the electronic device and prevents the financial transaction when the user is not the owner of the electronic device.

The method can use biometric data to determine if the user is the owner of the electronic device in a variety of ways. For example, the electronic device may contain a camera for taking a picture of the face of the user of the electronic device. That picture can be used for comparing facial features of the picture to the biometric data of a picture of the owner pre-stored in the electronic device. Alternatively, the electronic device can contain a device for taking a fingerprint of the user of the electronic device. That fingerprint can then be compared to the biometric data of a fingerprint pre-stored in the electronic device. Additionally, a scanning device on the electronic device may conduct a retinal scan of an eye of the user of the electronic device and compare the retinal scan to the biometric data stored in the electronic device. Other biometric data can be used to verify that the user of the electronic device is an authorized user.

The method may also perform other functions and have other features. For example, the electronic device can communicate with the chip through a subscriber identity module (SIM) card interface in the electronic device. The electronic device could retrieve SIM card information about a cellular network on the chip in order to wirelessly connect to the network. This can allow the electronic device to conduct the financial transaction in that cellular network.

Another configuration of the preferred embodiment is a method of paying labor. The method may begin by determining an amount of labor that has been worked by a laborer. For example, a number of hours worked can be tabulated. Next, a compensation amount is calculated for that amount of labor. This may involve multiplying the number of hours worked by an hourly wage. After that, a personal credit device that has earlier been assigned to the laborer is credited with that compensation. The personal credit device can be a credit card. A credit machine such as an automatic teller machine (ATM) is placed near a location where the laborer works. This allows the laborer easy access to at least a portion of his compensation when he needs it. The laborer can insert his personal credit device into the credit machine. This allows the laborer to enter a request for an amount of cash and for the credit machine to receive that request. The credit machine/ATM can verify that an authorized user made the request for cash at the credit machine. For example, the requester of the transaction may be required to enter a personal identification number (PIN) into the credit machine. An authorized user would be the owner of the personal credit device or others he so designates. Once the user is determined authorized to use the personal credit device, the cash is dispensed at the credit machine equal to the amount of cash requested.

### BRIEF DESCRIPTION OF SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a preferred embodiment of an electronic device operating in a wireless environment that can verify financial transactions.

FIG. 2 illustrates an embodiment of a method for verifying financial transactions at an electronic device.

Similar numbers refer to similar parts throughout the drawings.

### DETAILED DESCRIPTION

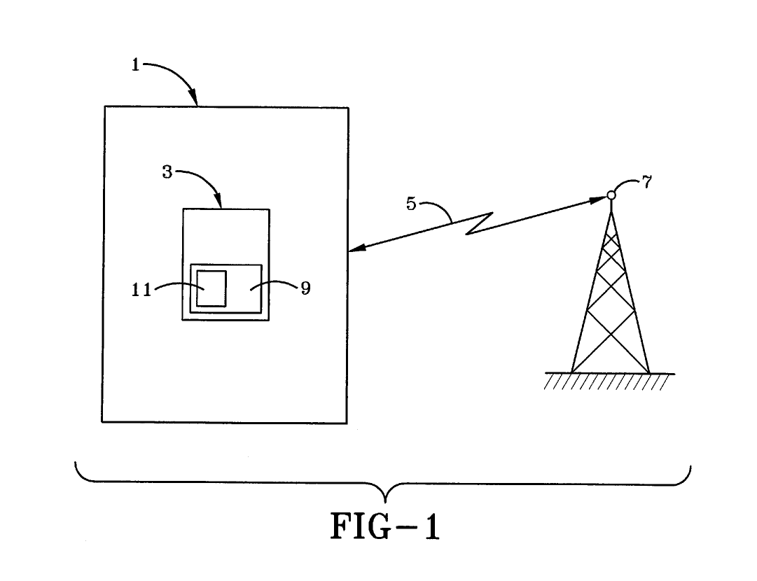

FIG. 1 illustrates the preferred embodiment of an electronic device 1 with an electronic chip 3 that may be a silicon chip that is used to verify electronic transactions. As discussed below, the chip 3 can contain hardware comparison logic and store data that is used to verify that a person using the electronic device 1 is the true owner of that device so that the financial transaction being conducted using the electronic device 1 is valid. The electronic device 1 can be a cellular telephone or another type of device that transmits and receives wireless signals 5 to a cellular antenna 7 on a cellular tower or another type of antenna.

“Logic”, as used herein, includes but is not limited to hardware, firmware, software and/or combinations of each to perform a function(s) or an action(s), and/or to cause a function or action from another logic, method, and/or system. For example, based on a desired application or need, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

In the preferred embodiment, the chip 3 can operate in parallel with a subscriber identity module (SIM) card that is often found in a cellular telephone and other devices that connect to a cellular network. For example, the chip 3 can be thin enough so that it can be plugged into a SIM socket in the electronic device together with a SIM card or it can be fabricated as part of the SIM card.

Alternatively, the chip 3 can replace a SIM card in the electronic device 1. In that case, it may be formed in the same shape of a SIM card and have the same connections as a SIM card. This chip that “replaces” a SIM card of the electronic device 1 can be loaded with all or some of the information that the SIM card would have carried. It can also perform some or all of the actions of the SIM card that it is replacing in addition to the authentication features discussed below.

Before describing how the chip 3 can be used to verify almost any electronic transaction from the electronic device 1, a short review of how a SIM card can be used to verify that it is authorized to access a particular cellular network is discussed. The authentication process is started when the electronic device 1 powers up. The device obtains an International Mobile Subscriber Identity (IMSI) from the SIM card, and passes this to the mobile operator (the cellular network's owner) requesting access and authentication to the network. The electronic device 1 may have to pass a PIN to the SIM card before the SIM card will reveal this information. Next, if the PIN is verified, the operator network searches its database for the incoming IMSI and its associated authentication/cryptographic key (Kᵢ). The operator network then also generates a Random Number (RAND, which is a nonce) and signs it with the Kᵢ associated with the IMSI (and stored on the SIM card), computing another number known as Signed Response 1 (SRES_1). The operator network then sends the RAND to the electronic device 1, which passes it to the SIM card. The SIM card performs a cryptographic calculation in it that allows it to sign a message from the operator network with its stored Kᵢ to produce a signed response 2 (SRES_2), which it gives to the electronic device 1 along with encryption key K_{c}. The electronic device passes SRES_2 on to the operator network. The operator network then compares its computed SRES_1 with the computed SRES_2 that the electronic device 1 returned. If the two numbers match, the SIM is authenticated and the electronic device 1 is granted access to the operator's network. After that, another cypher/encryption key (K_{c}) is used to encrypt all further communications between the electronic device 1 and the network.

Rather than just verifying whether the electronic device 1 is authorized to connect to a network, the preferred embodiment of the electronic device 1 and its chip 3 stores biometric data 11 of the device's owner in a memory 9 on the chip 3. Ideally this data is stored at the time the electronic device 1 is purchased or assigned to a user. At that time, biometric data 11 is taken of the user and is then electronically formatted and stored in the memory 9 of the chip 3. This stored biometric data can then later be compared to biometric data 11 of a user of the device to see if they are also the owner of the electronic device 1 and, thus, permitted to make a financial transaction.

For example a picture can be taken of the person authorized to make financial transactions on the device 1 and then stored into a memory 9 on the chip 3. If desired, the picture data can be encrypted using a special key that only the chip 3 has knowledge of so that later an unauthorized person cannot merely store their own unencrypted picture in the chip 3 in an effort to add themselves as an authorized user even though they are not. At the time a user of the electronic device 1 desires to make a financial transaction, they can be prompted to use a camera built into the electronic device 1 to take their picture. Face recognition software stored in the device 1 can then compare the pre-stored picture to the currently taken picture and if the two match then it can allow the transaction to be completed. Of course, if the pictures are not verified to be of the same person then the transaction will not be permitted.

In addition to or instead of using facial photographs of the authorized user of the electronic device 1, other biometric data and comparisons can be made at the electronic device 1. For example, the electronic device 1 could have a retinal scanner that can scan an eye of the user of electronic device 1. Comparison logic in the electronic device can compare this scan to pre-stored retinal scan data. Also, finger print(s) can be taken and compared to pre-stored representation of finger prints of the owner of the electronic device. In other configurations other biometric data can be used.

In addition to authenticating financial transactions, another configuration of the preferred embodiment discussed below helps in some situations to ensure that only an authorized person (or their beneficiaries such as their spouse for example) receives and uses payments made to them. These situations can involve, for example, seasonal farm help that often desires to be paid the day they perform their work or as soon as possible after. However, often it is not economical (or safe) for their employer to keep that amount of cash on hand and the overhead cost of providing daily payments can be high. Similar situations often occur in lesser developed countries where labor is periodically paid a couple times a month and are often robbed at those times by criminals that know what day the payments are made.

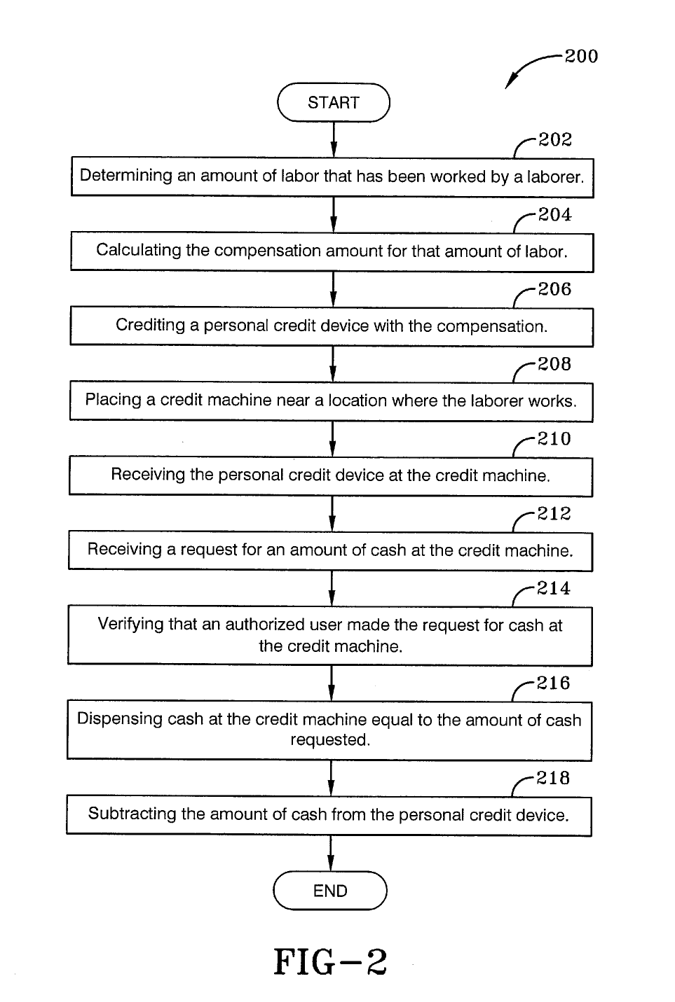

FIG. 2 illustrates an example method 200 of making payments to laborers and how they use at least some of those payments. This method of this configuration of the invention will be with reference to a flow diagram (FIG. 2). While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

Method 200 involves the use of credit devices rather than payment in checks or cash. These credit devices allow for method 200 to provide a way of paying migrant labor (and other labor) more often and in a more secure way than is normally possible. The method 200 starts by determining an amount of labor that has been worked by a laborer, at 202. For example, the amount of labor worked could be a certain number of hours worked in a day or over several days or another time period. A compensation for that amount of labor is calculated, at 204. For example, the numbers of hours worked can be multiplied by an hourly wage. That compensation is then credited to the personal credit device, at 206, that has earlier been assigned to that laborer. The personal credit device can be a credit card, debit card or the like. Paying labor in this way prevents theft of cash if they were to be paid in cash. Applying credit to a personal credit device also is very efficient because it does not require the keeping of cash on hand for payments made directly to individuals. The personal credit device can have personal identification codes (PINs) or other authentication features so that only the owner (or those they designate) may access funds stored on his personal credit device.

The person or business that credits the personal credit device can bring a credit machine such as an automatic teller machine (ATM) to a safe location, at 208, where the laborer(s) may desire to have access to some of their cash. That location can be where they relax when not working. This allows them to access some or all of their credit in a safe way. To access their credit, they can insert their personal credit device into the credit machine and the credit machine receives it, at 210. The credit machine next receives, at 212, a request for cash. Next, or before the request for cash, the credit machine verifies, at 214, that the person that has inserted the personal credit device into the machine is the owner of credit device. For example, a PIN can be request and verified as belonging to that credit device or another way may be used to make such verification. Cash is dispensed at the credit machine equal to the amount requested, at 216, upon the person being properly verified. The amount of cash withdrawn is subtracted from the personal credit device, at 218, and the personal credit device can be returned to its owner. Later the credit machine can be removed when laborers no longer need access to it, or it can be moved to a new location where the laborers are more likely to need access to cash. Thus, method 200 provides for a secure way pay laborers that is secure, safe and timely.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A wireless phone configured to conduct financial transactions comprising:
a chip configured to store authentication credentials;
detection logic configured to detect when the wireless phone is within range of a wireless network;
authentication logic configured to authenticate the wireless phone with a wireless network using the stored authentication credentials, wherein when the wireless phone is authenticated with the wireless network the wireless phone configured to conduct financials transaction over the wireless network without requiring further authentication.

2. The wireless phone configured to conduct financial transactions of claim 1 wherein the chip is a subscriber identity module (SIM) card and the authentication logic is configured to authenticate the wireless phone with information stored on the SIM card.

3. The wireless phone configured to conduct financial transactions of claim 1 wherein the financial transactions includes purchasing an item over the wireless network.

4. The wireless phone configured to conduct financial transactions of claim 1 wherein the authentication credentials are biometric data of an owner of the wireless phone.

5. An electronic device capable of authorizing financial transactions comprising:
an electronic chip;
a memory in the chip configured to store authentication data of an owner of the electronic device, wherein the electronic device is configured to detect a request for a financial transaction is being made at the electronic device, wherein upon that detection the electronic device is configured to receive authentication data from a user of the electronic device and to compare the received authentication data to authentication data stored in the memory to determine if the user of the electronic device is the owner of the electronic device, and wherein the electronic device is configured to allow the financial transaction proceed when the user is the owner and not to proceed when the user is not the owner.

6. The electronic device of claim 5 wherein the electronic device is a cellular telephone.

7. The electronic device of claim 5 wherein the electronic chip further comprises:
an input/output interface that is compatible with subscriber identity module (SIM) card interface that is built into the electronic device, wherein the electronic chip is configured to communicate with the electronic device through the SIM card interface.

8. The electronic device of claim 5 further comprising:
an input device configured to take biometric data from a user of the electronic device and input it into the electronic device, wherein the input device is at least one of the group of: a camera, a retinal scanner and/or a fingerprint scanner.

9. The electronic device of claim 5 wherein the authentication data is biometric data.

10. The electronic device of claim 5 wherein the chip is attached to a subscriber identity module (SIM) card.

11. A method of verifying a financial transaction at least partially conducted at an electronic device comprising:
determining a request for a financial transaction is being requested at the electronic device;
reading biometric data from an electronic chip in the electronic device;
receiving biometric data from a user of the electronic device;
comparing the biometric data from the electronic chip to the biometric data received from the user of the electronic device to determine if the user is an authorized user of the electronic device; and
allowing the financial transaction to be conducted with the electronic device when the user of the electric device is an authorized user of the electronic device and preventing the financial transaction when the user is not an authorized user of the electronic device.

12. The method of verifying a financial transaction at least partially conducted at an electronic device of claim 11 further comprising:
storing biometric data into the chip in the electronic device at a time the electronic device is assigned to an authorized user of the electronic device.

13. The method of verifying a financial transaction at least partially conducted at an electronic device of claim 11 further comprising:
communicating with the chip through a subscriber identity module (SIM) card interface in the electronic device.

14. The method of verifying a financial transaction at least partially conducted at an electronic device of claim 11 further comprising:
retrieving subscriber identity module (SIM) card information about a cellular network from the chip.

15. The method of verifying a financial transaction at least partially conducted at an electronic device of claim 11 further comprising:
taking a picture of the face of the user of the electronic device, and wherein the comparing further comprises:
comparing facial features of the picture to the biometric data stored in the chip.

16. The method of verifying a financial transaction at least partially conducted at an electronic device of claim 11 further comprising:
at the electronic device, taking a fingerprint of the user of the electronic device;
comparing the fingerprint to the biometric data stored in the chip.

17. The method of verifying a financial transaction at least partially conducted at an electronic device of claim 11 further comprising:
conducting a retinal scan of an eye of the user of the electronic device;
and comparing the retinal scan to the biometric data stored in the chip.

18. A method of paying for labor comprising:
crediting a personal credit device assigned to a laborer with a compensation amount;
placing a credit machine near a location where the laborer works;
receiving the personal credit device at the credit machine;
receiving a request for an amount of cash at the credit machine;
verifying that an authorized user made the request for cash at the credit machine; and
dispensing cash at the credit machine equal to the amount of cash requested.

19. The method of paying for the labor of claim 18 further comprising:
determining an amount of labor that has been worked by a laborer; and
calculating the compensation amount for that amount of labor based on the amount of labor that has been worked.

20. The method of paying for the labor of claim 18 wherein the crediting further comprises:
adding the compensation amount to a total value amount stored on the personal credit device, and
subtracting the amount of cash requested from the total value amount stored on the personal credit device.
